(19) United States
(12) Patent Application Publication
(10) Pub. No.: US 2012/0274626 A1
(43) Pub. Date: Nov. 1, 2012

(54) Stereoscopic Image Generating Apparatus and Method

(75) Inventor: Chia-Ming Hsieh, Tainan City (TW)

(73) Assignee: HIMAX MEDIA SOLUTIONS, INC., Tainan City (TW)

(21) Appl. No.: 13/097,528

(22) Filed: Apr. 29, 2011

(51) Int. Cl. G06T 15/08

(52) U.S. Cl. 345/419

(57) ABSTRACT

A depth map generating device. A first depth information extractor extracts a first depth information from a main two dimensional (2D) image according to a first algorithm and generates a first depth map corresponding to the main 2D image. A second depth information extractor extracts a second depth information from a sub 2D image according to a second algorithm and generates a second depth map corresponding to the sub 2D image. A mixer mixes the first depth map and the second depth map according to adjustable weighting factors to generate a mixed depth map. The mixed depth map is utilized for converting the main 2D image to a set of three dimensional (3D) images.

### BACKGROUND OF THE INVENTION

1. Field of the Invention

The invention relates to a stereoscopic image generating apparatus, and more particularly to a stereoscopic image generating apparatus for generating stereoscopic images with more accurate depth information.

2. Description of the Related Art

Modern three dimensional (3D) displays enhance visual experiences when compared to conventional two dimensional (2D) displays and benefit many industries, such as the broadcasting, movie, gaming, and photography industries, etc. Therefore, 3D video signal processing has become a trend in the visual processing field.

However, a major challenge in producing 3D images is to generate a depth map. Because 2D images captured by an image sensor don't have pre-recorded depth information, lack of an effective 3D image generation method is problematic in the 3D industry, when based upon 2D images. In order to effectively produce 3D images so that users can fully experience the 3D images, an effective 2D-to-3D conversion system and method is highly required.

### BRIEF SUMMARY OF THE INVENTION

A depth map generating device, stereoscopic image generating apparatus and stereoscopic image generating method are provided. An exemplary embodiment of a depth map generating device comprises a first depth information extractor, a second depth information extractor, and a mixer. The first depth information extractor extracts a first depth information from a main two dimensional (2D) image according to a first algorithm and generates a first depth map corresponding to the main 2D image. The second depth information extractor extracts a second depth information from a sub 2D image according to a second algorithm and generates a second depth map corresponding to the sub 2D image. The mixer mixes the first depth map and the second depth map according to adjustable weighting factors to generate a mixed depth map. The mixed depth map is utilized for converting the main 2D image to a set of three dimensional (3D) images.

An exemplary embodiment of a stereoscopic image generating apparatus comprises a depth map generating device, and a depth image based rendering device. The depth map generating device extracts a plurality of depth information from a main 2D image and a sub 2D image and generates a mixed depth map according to the extracted depth information. The depth image based rendering device generates a set of 3D images according to the main 2D image and the mixed depth map.

An exemplary embodiment of a stereoscopic image generating method comprises: extracting a first depth information from a main two dimensional (2D) image to generate a first depth map corresponding to the main 2D image; extracting a second depth information from a sub 2D image to generate a second depth map corresponding to the sub 2D image; mixing the first depth map and the second depth map according to a plurality of adjustable weighting factors to generate a mixed depth map; and generating a set of three dimensional (3D) images according to the main 2D image and the mixed depth map.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram illustrating a stereoscopic image generating apparatus according to an embodiment of the invention;

FIG. 2 is a block diagram illustrating a depth map generating device according to an embodiment of the invention;

FIG. 3 shows an exemplary 2D image according to an embodiment of the invention;

FIG. 4 shows an exemplary location based depth map obtained according to the 2D image as shown in FIG. 3 according to an embodiment of the invention;

FIG. 5 shows an exemplary color based depth map obtained according to the 2D image as shown in FIG. 3 according to an embodiment of the invention;

FIG. 6 shows an exemplary edge based depth map obtained according to the 2D image as shown in FIG. 3 according to an embodiment of the invention;

FIG. 7 shows an exemplary mixed depth map according to an embodiment of the invention;

FIG. 8 shows an exemplary mixed depth map according to another embodiment of the invention;

FIG. 9 shows an exemplary mixed depth map according to yet another embodiment of the invention;

FIG. 10 shows a flow chart of a stereoscopic image generating method according to an embodiment of the invention; and

FIG. 11 shows a flow chart of a stereoscopic image generating method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

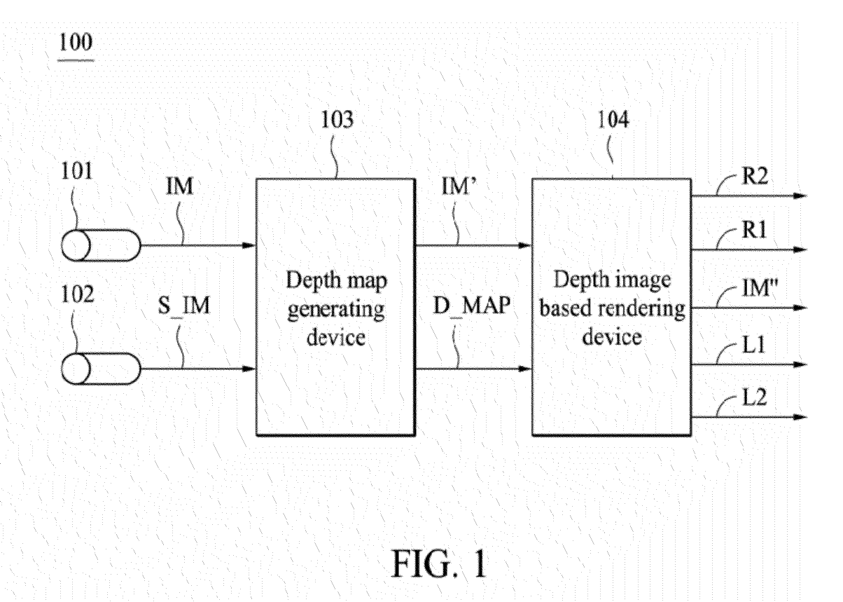

FIG. 1 is a block diagram illustrating a stereoscopic image generating apparatus according to an embodiment of the invention. In one embodiment of the invention, the stereoscopic image generating apparatus 100 may comprise more than one sensor (i.e., image capture device), such as the sensors 101 and 102, a depth map generating device 103 and a depth image based rendering (DIBR) device 104. According to an embodiment of the invention, the sensor 101 may be regarded as a main sensor for capturing a main 2D image IM, and the sensor 102 may be regarded as a sub sensor for capturing a sub 2D image S_IM. Because the sensors 101 and 102 are disposed with a distance, the sensors 101 and 102 may be utilized for capturing images of the same scene from different angles.

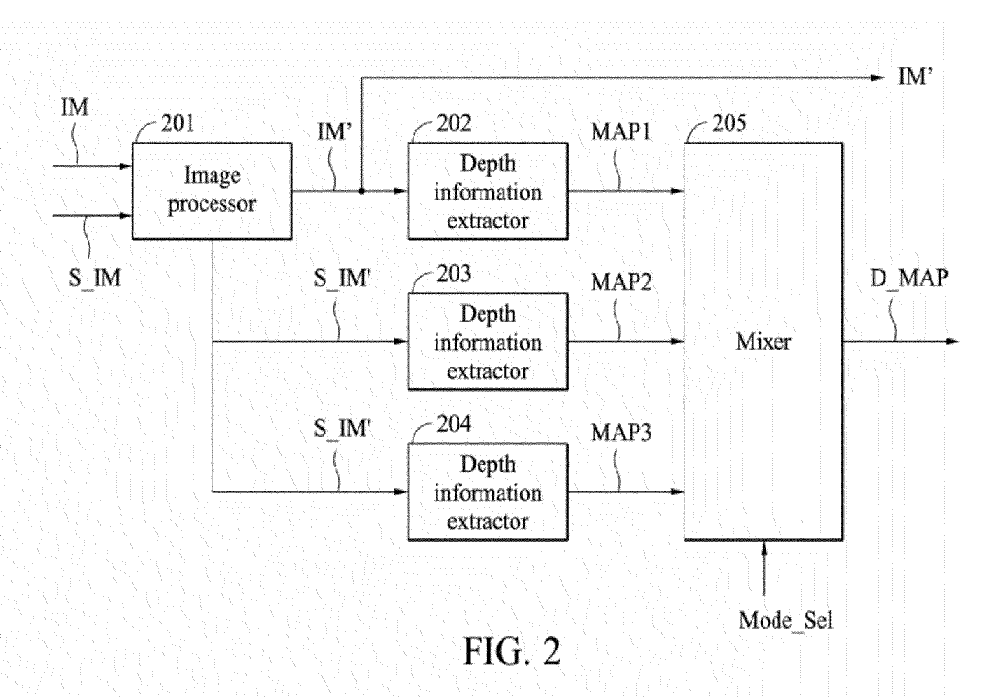

According to an embodiment of the invention, the depth map generating device 103 may receive the main 2D image IM and the sub 2D image S_IM from the sensors 101 and 102, respectively, and process the main 2D image IM (and/or the sub 2D image S_IM) to generate the processed image IM′ (and/or the processed image S_IM′ as shown in FIG. 2). The depth map generating device 103 may filter out a noise portion in the captured main 2D image IM (and/or the sub 2D image S_IM) to generate processed image IM′ (and/or the processed image S_IM′ as shown in FIG. 2). Note that in some embodiments of the invention, the depth map generating device 103 may also perform other image processing processes on the main 2D image IM (and/or the sub 2D image S_IM) to generate a processed image IM′ (and/or the processed image S_IM′ as shown in FIG. 2), or directly pass the main 2D image IM to the depth image based rendering device 104 without first being processed, and the invention should not be limited thereto. According to an embodiment of the invention, the depth map generating device 103 may further extract a plurality of depth information from the main 2D image IM and the sub 2D image S_IM (or from the processed images IM′ and S_IM′) and generate a mixed depth map D_MAP according to the extracted depth information.

FIG. 2 is a block diagram illustrating a depth map generating device according to an embodiment of the invention. In one embodiment of the invention, the depth map generating device may comprise an image processor 201, a first depth information extractor 202, a second depth information extractor 203, a third depth information extractor 204 and a mixer 205. The image processor 201 may process the main 2D image IM and/or the sub 2D image S_IM to generate and output the processed image IM′ and/or S_IM′. Note that as previously described, the image processor 201 may also directly pass and output the main 2D image IM and/or the sub 2D image S_IM without first being processed, so that in some embodiments of the invention, the processed image IM′ and S_IM′ may be identical to the main 2D image IM and the sub 2D image S_IM, respectively.

According to an embodiment of the invention, the first depth information extractor 202 may extract a first depth information from the un-processed or processed main 2D image IM or IM′ according to a first algorithm and generate a first depth map MAP1 corresponding to the main 2D image. The second depth information extractor 203 may extract a second depth information from the un-processed or processed sub 2D image S_IM or S_IM′ according to a second algorithm and generate a second depth map MAP2 corresponding to the sub 2D image. The third depth information extractor 204 may extract a third depth information from the un-processed or processed sub 2D image S_IM or S_IM′ according to a third algorithm and generate a third depth map MAP3 corresponding to the sub 2D image. The mixer 205 may mix at least two of the received depth maps MAP1, MAP2 and MAP3 according to a plurality of adjustable weighting factors to generate the mixed depth map D_MAP.

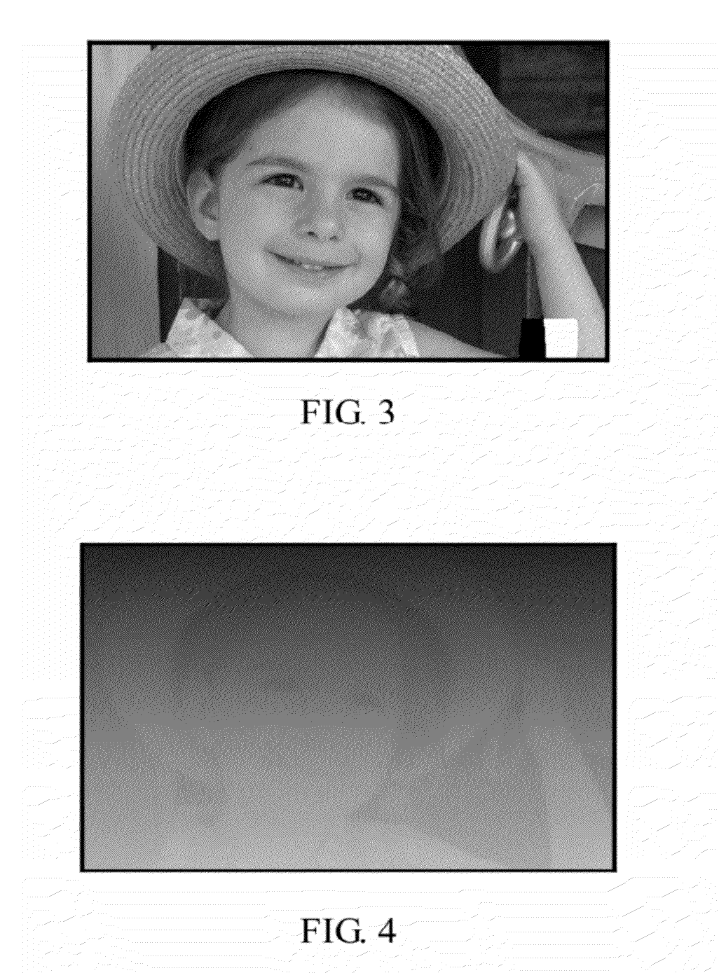

According to an embodiment of the invention, the first algorithm utilized for extracting the first depth information may be a location based depth information extracting algorithm. According to the location based depth information extracting algorithm, distances of one or more objects in the 2D image may first be estimated. Then, the first depth information may be extracted according to the estimated distances, and finally a depth map may be generated according to the first depth information. FIG. 3 shows an exemplary 2D image according to an embodiment of the invention, in which a girl wearing an orange hat is presented. According to the concept of the location based depth information extracting algorithm, it is supposed that the objects in the lower vision area are closer to the viewer. Thus, the edge-features of the 2D image may first be obtained, and then be accumulated horizontally from a top of the 2D image to a bottom to get an initial scene depth map. In addition, it is further supposed that for visual perception, viewers interpret warm color objects as being closer than cold color objects. Therefore, the texture values of the 2D image may also be obtained by, for example, analyzing the colors of the objects in the 2D image from the color space (such as Y/U/V, Y/Cr/Cb, R/G/B, or others). The initial scene depth map may be mixed with the texture values so as to obtain the location based depth map as shown in FIG. 4. For more detail of the location based depth information extracting algorithm, reference may be made to the publication of “An Ultra-Low-Cost 2-D/3-D Video-Conversion System”, which was published in 2010 by the Society for Information Display (SID).

According to an embodiment of the invention, the extracted depth information may be represented as a depth value. As the exemplary location based depth map shows in FIG. 4, each pixel of the 2D image may have a corresponding depth value so that a collection of the depth values forms the depth map. The depth value may range from 0 to 255, where the larger depth value means that the object is closer to the viewer, and a corresponding position in the depth map may be represented by being brighter. As a result, in the obtained location based depth map shown in FIG. 4, the lower vision area is brighter than the higher vision area, and the hat, cloths, face, and hand portions of the girl as shown in FIG. 3 are also brighter than the background objects. Therefore, the lower vision area and the hat, cloths, face, and hand portions of the girl may be regarded as being closer to the viewer than the other objects.

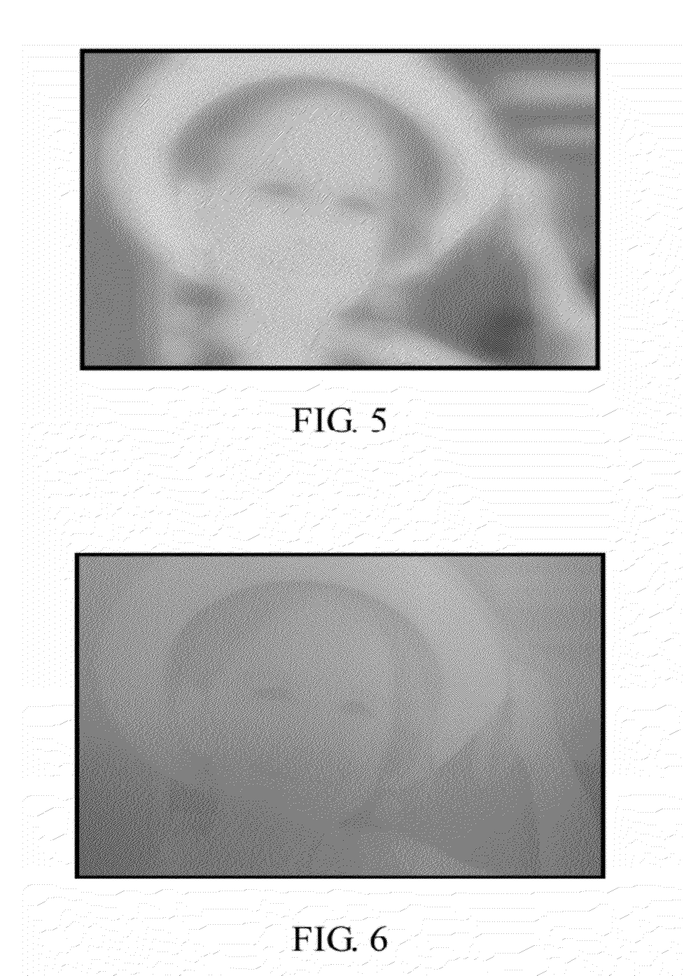

According to another embodiment of the invention, the second algorithm utilized for extracting the second depth information may be a color based depth information extracting algorithm. According to the color based depth information extracting algorithm, colors of one or more objects in the 2D image may first be analyzed from the color space (such as Y/U/V, Y/Cr/Cb, R/G/B, or others). Then, the second depth information may be extracted according to the analyzed colors, and finally a depth map may be generated according to the second depth information. As previously described, it is supposed that viewers interpret warm color objects as being closer than cold color objects when visually perceived. Therefore, a larger depth value may be assigned to the pixel with warm colors (such as red, orange, yellow, and others), and a smaller depth value may be assigned to the pixel with cold colors (such as blue, violet, cyan, and others). FIG. 5 shows an exemplary color based depth map obtained according to the 2D image as shown in FIG. 3 according to an embodiment of the invention. As shown in FIG. 5, the hat, cloths, face, and hand portions of the girl as shown in FIG. 3 are represented in warm colors and therefore, are brighter (i.e. having larger depth values) than the other portions in the obtained depth map.

According to yet another embodiment of the invention, the third algorithm utilized for extracting the third depth information may be an edge based depth information extracting algorithm. According to the edge based depth information extracting algorithm, edge features of one or more objects in the 2D image may first be detected. Then, the third depth information may be extracted according to the detected edge features, and finally a depth map may be generated according to the third depth information. According to an embodiment of the invention, the edge features may be detected by applying a high pass filter (HPF) on the 2D image to obtain a filtered 2D image. The HPF may be implemented by an at least one dimensional array. The pixel values of the filtered 2D image may be regarded as the detected edge features. A corresponding depth value may be assigned to each of the detected edge features, so as to obtain the edge based depth map. A low pass filter (LPF) may also be applied on the overall obtained edge features of the 2D image before a corresponding depth value is assigned to each of the detected edge features. The LPF may be implemented by an at least one dimensional array.

Based on the concept of the edge based depth information extracting algorithm, it is supposed that viewers perceive that the edges of an object are closer than the center of the object. Therefore, a larger depth value may be assigned to the pixels at the edges of an object (i.e. the pixels having larger edge features or the pixels having large average differences as previously described), and a smaller depth value may be assigned to the pixels in the center of the object so as to enhance the shape of the objects in the 2D image. FIG. 6 shows an exemplary edge based depth map obtained according to the 2D image as shown in FIG. 3, according to an embodiment of the invention. As shown in FIG. 6, the edges of the objects as shown in FIG. 3 are brighter (i.e. having larger depth values) than the other portions in the obtained depth map.

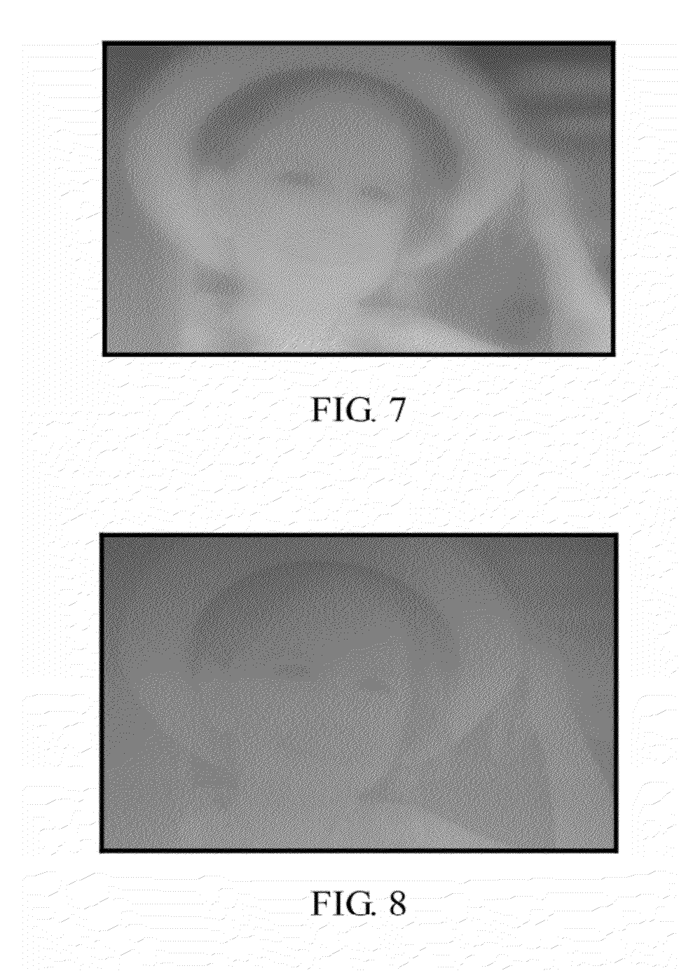

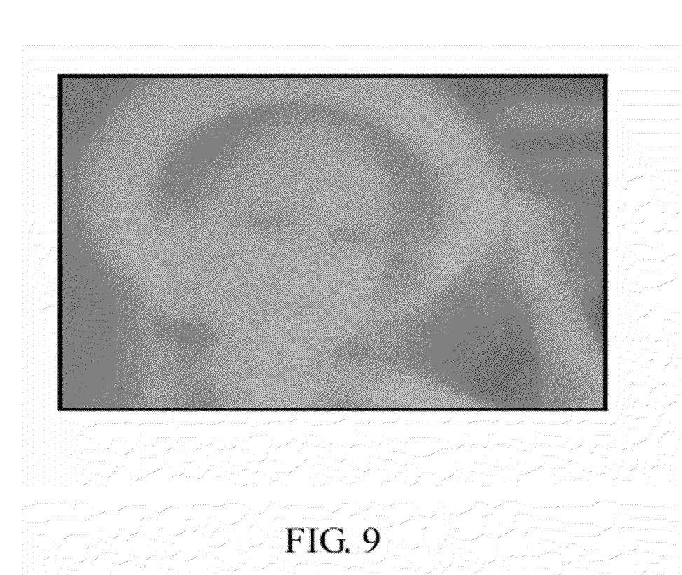

Note that the depth information may also be obtained based on other features according to other algorithms, and the invention should not be limited to the location based, color based, and edge based embodiments as described above. Referring back to FIG. 2, after obtaining the depth maps MAP1, MAP2 and MAP3, the mixer 205 may mix at least two of the received depth maps MAP1, MAP2 and MAP3 according to a plurality of adjustable weighting factors to generate the mixed depth map D_MAP. As an example, the mixer 205 may mix the location based depth map as shown in FIG. 4 and the color based depth map as shown in FIG. 5 to obtain an mixed depth map as shown in FIG. 7. As another example, the mixer 205 may mix the location based depth map as shown in FIG. 4 and the edge based depth map as shown in FIG. 6 to obtain a mixed depth map as shown in FIG. 8. As yet another example, the mixer 205 may mix the location based depth map as shown in FIG. 4, the color based depth map as shown in FIG. 5 and the edge based depth map as shown in FIG. 6 to obtain a mixed depth map as shown in FIG. 9.

According to an embodiment of the invention, the mixer 205 may receive a mode selection signal Mode_Sel indicating a mode selected by a user and utilized for capturing the main and sub 2D images, and determine the weighting factors according to the mode selection signal Mode_Sel. The mode selected by the user for capturing the main and sub 2D images may be selected from a group comprising a night scene mode, a portrait mode, a sports mode, a close-up mode, a night portrait mode, or others. Because when different modes are utilized for capturing the main and sub 2D images, different parameters, such as the exposure times, focus lengths etc., may be applied. Therefore, different weighting factors may be applied, accordingly, for generating the mixed depth map. For example, in the portrait mode, the weighting factors may be 0.7 and 0.3 for mixing the first depth map and the second depth map. That is, the depth values in the first depth map may be multiplied by 0.7, and the depth values of the second depth map may be multiplied by 0.3, and the corresponding weighted depth values in the first and second depth maps may be summed to obtain the mixed depth map D_MAP.

Referring back to FIG. 1, after obtaining the mixed depth map D_MAP, the depth image based rendering device 104 may generate a set of three dimensional (3D) images (such as the IM″, R1, R2, L1, L2 as shown) according to the main 2D image IM and the mixed depth map D_MAP. According to an embodiment of the invention, the image IM″ be a further processed version of the main 2D image IM or the processed image IM′. The image IM″ may be processed by noise filtering, sharpening, or others. The images L1, L2, IM″, R1 and R2 are the 3D images with different view, where the image L2 and R2 may represent the leftest and most right view for the medium image IM″, respectively. The image L2 (or R2) may also represent the view between the images L1 (or R1) and IM″. The set of 3D images may further be transmitted to a format conversion device (not shown) for operating format conversion so as to be displayed on a display panel (not shown). The format conversion algorithm may be a design based on the requirements of the display panel. Note that the depth image based rendering device 104 may also generate the 3D images for the right eye and left eye at more than two different view angles so that the final 3D image may create the 3D effect for more than two view points and the invention should not be limited thereto.

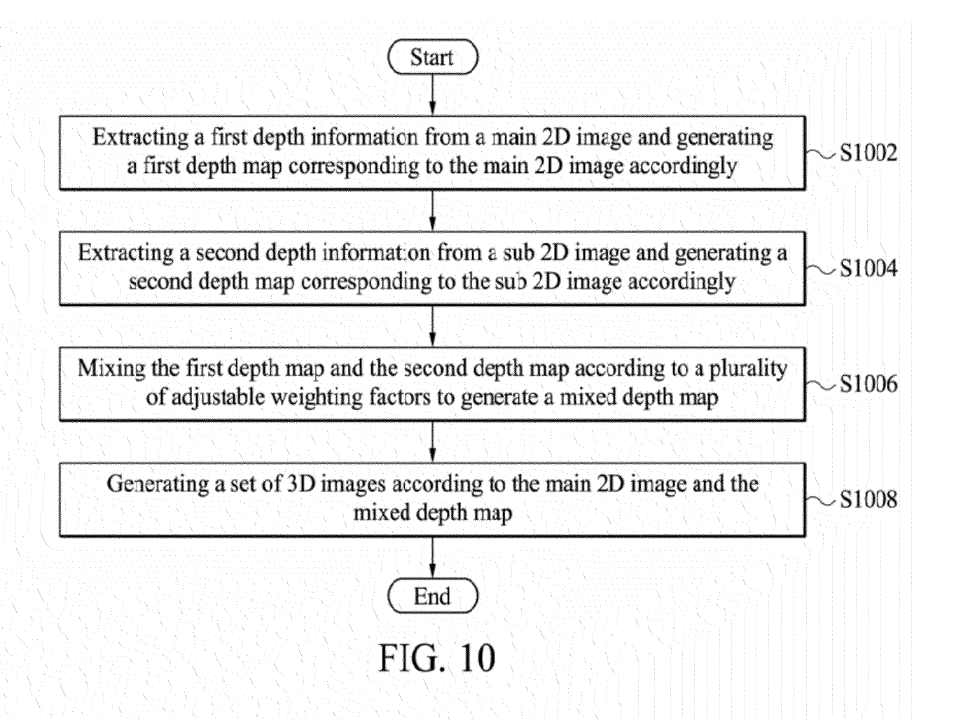

FIG. 10 shows a flow chart of a stereoscopic image generating method according to an embodiment of the invention. To begin, a first depth information is extracted from a main 2D image and a first depth map corresponding to the main 2D image is generated accordingly (Step S1002). Next, a second depth information is extracted from a sub 2D image and a second depth map corresponding to the sub 2D image is generated accordingly (Step S1004). Next, the first depth map and the second depth map are mixed according to a plurality of adjustable weighting factors to generate a mixed depth map (Step S1006). Finally, a set of 3D images are generated according to the main 2D image and the mixed depth map (Step S1008).

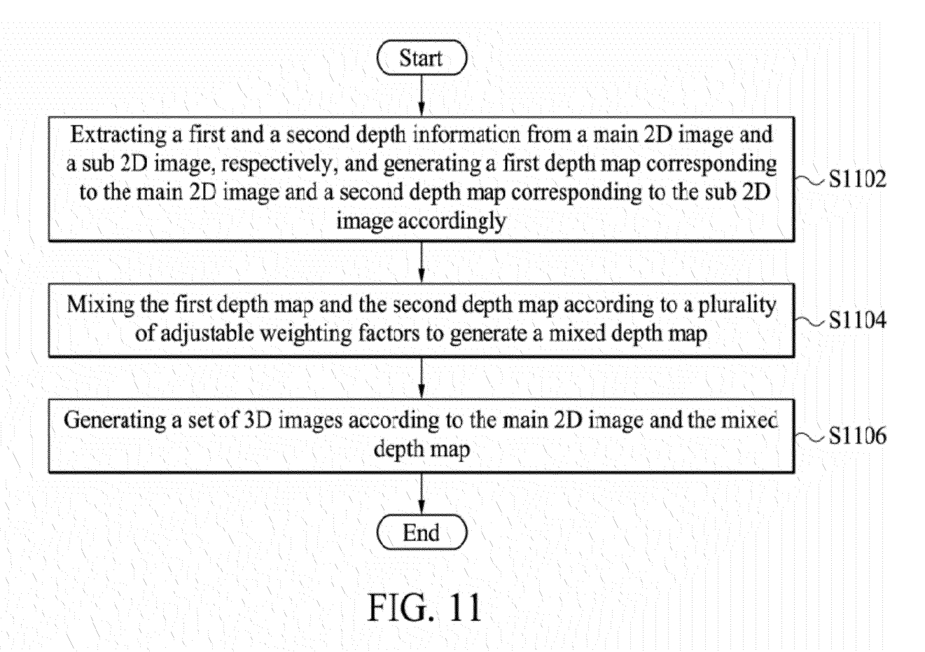

FIG. 11 shows a flow chart of a stereoscopic image generating method according to another embodiment of the invention. In the embodiment, the first and second depth information may be extracted in parallel, and the first and second depth maps may be simultaneously generated, accordingly. To begin, a first and a second depth information are simultaneously extracted from a main 2D image and a sub 2D image, respectively, and a first depth map corresponding to the main 2D image and a second depth map corresponding to the sub 2D image are generated accordingly (Step S1102). Next, the first depth map and the second depth map are mixed according to a plurality of adjustable weighting factors to generate a mixed depth map (Step S1104). Finally, a set of 3D images are generated according to the main 2D image and the mixed depth map (Step S1106). Note that in yet another embodiment of the invention, the first, second and third depth information may also be extracted in parallel based on the same concept, and the first, second and third depth maps are generated, accordingly. Thereafter, the first, second and third depth maps are mixed to generate a mixed depth map, and a set of 3D images are generated according to the main 2D image and the mixed depth map.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A depth map generating device, comprising:
a first depth information extractor, extracting a first depth information from a main two dimensional (2D) image according to a first algorithm and generating a first depth map corresponding to the main 2D image;
a second depth information extractor, extracting a second depth information from a sub 2D image according to a second algorithm and generating a second depth map corresponding to the sub 2D image; and
a mixer, mixing the first depth map and the second depth map according to a plurality of adjustable weighting factors to generate a mixed depth map,
wherein the mixed depth map is utilized for converting the main 2D image to a set of three dimensional (3D) images.

2. The depth map generating device as claimed in claim 1, wherein the first algorithm is a location based depth information extracting algorithm, by which the first depth information is extracted according to estimated distances of one or more objects in the main 2D image.

3. The depth map generating device as claimed in claim 1, wherein the second algorithm is a color based depth information extracting algorithm, by which the second depth information is extracted according to colors of one or more objects in the sub 2D image.

4. The depth map generating device as claimed in claim 1, wherein the second algorithm is an edge based depth information extracting algorithm, by which the second depth information is extracted according to detected edge features of one or more objects in the sub 2D image.

5. The depth map generating device as claimed in claim 1, further comprising:
a third depth information extractor, extracting a third depth information from the sub 2D image according to a third algorithm and generating a third depth map corresponding to the sub 2D image,
wherein the mixer mixes the first depth map, the second depth map and the third depth map according to the adjustable weighting factors to generate the mixed depth map.

6. The depth map generating device as claimed in claim 1, wherein the third algorithm is an edge based depth information extracting algorithm, by which the third depth information is extracted according to detected edge features of one or more objects in the sub 2D image.

7. A stereoscopic image generating apparatus, comprising:
a depth map generating device, extracting a plurality of depth information from a main two dimensional (2D) image and a sub 2D image and generating a mixed depth map according to the extracted depth information; and
a depth image based rendering device, generating a set of three dimensional (3D) images according to the main 2D image and the mixed depth map.

8. The stereoscopic image generating apparatus as claimed in claim 7, further comprising:
a main sensor, capturing the main 2D image; and
a sub sensor, capturing the sub 2D image.

9. The stereoscopic image generating apparatus as claimed in claim 7, wherein the depth map generating device comprises:
a first depth information extractor, extracting a first depth information from the main 2D image according to a first algorithm and generating a first depth map corresponding to the main 2D image;
a second depth information extractor, extracting a second depth information from the sub 2D image according to a second algorithm and generating a second depth map corresponding to the sub 2D image; and
a mixer, mixing the first depth map and the second depth map according to a plurality of adjustable weighting factors to generate the mixed depth map.

10. The stereoscopic image generating apparatus as claimed in claim 9, wherein the first algorithm is a location based depth information extracting algorithm, by which the first depth information is extracted according to estimated distances of one or more objects in the main 2D image.

11. The stereoscopic image generating apparatus as claimed in claim 9, wherein the second algorithm is a color based depth information extracting algorithm, by which the second depth information is extracted according to colors of one or more objects in the sub 2D image.

12. The stereoscopic image generating apparatus as claimed in claim 8, wherein the second algorithm is an edge based depth information extracting algorithm, by which the second depth information is extracted according to detected edge features of one or more objects in the sub 2D image.

13. The stereoscopic image generating apparatus as claimed in claim 9, wherein the depth map generating device further comprises:
a third depth information extractor, extracting a third depth information from the sub 2D image according to a third algorithm and generating a third depth map corresponding to the sub 2D image,
wherein the mixer mixes the first depth map, the second depth map and the third depth map according to the adjustable weighting factors to generate the mixed depth map.

14. The stereoscopic image generating apparatus as claimed in claim 13, wherein the third algorithm is an edge based depth information extracting algorithm, by which the third depth information is extracted according to detected edge features of one or more objects in the sub 2D image.

15. A stereoscopic image generating method, comprising:
extracting a first depth information from a main two dimensional (2D) image to generate a first depth map corresponding to the main 2D image;
extracting a second depth information from a sub 2D image to generate a second depth map corresponding to the sub 2D image;
mixing the first depth map and the second depth map according to a plurality of adjustable weighting factors to generate a mixed depth map; and
generating a set of three dimensional (3D) images according to the main 2D image and the mixed depth map.

16. The stereoscopic image generating method as claimed in claim 15, further comprising:
capturing the main 2D image by a main sensor; and
capturing the sub 2D image by a sub sensor.

17. The stereoscopic image generating method as claimed in claim 15, further comprising:
estimating distances of one or more objects in the main 2D image;
extracting the first depth information according to the estimated distances; and
generating the first depth map according to the first depth information.

18. The stereoscopic image generating method as claimed in claim 15, further comprising:
analyzing colors of one or more objects in the sub 2D image;
extracting the second depth information according to the analyzed colors; and
generating the second depth map according to the second depth information.

19. The stereoscopic image generating method as claimed in claim 15, further comprising:
extracting a third depth information from the sub 2D image to generate a third depth map corresponding to the sub 2D image; and
mixing the first depth map, the second depth map and the third depth map according to the adjustable weighting factors to generate the mixed depth map.

20. The stereoscopic image generating method as claimed in claim 19, further comprising:
detecting edge features of one or more objects in the sub 2D image;
extracting the third depth information according to the detected edge features; and
generating the third depth map according to the third depth information.
